(19) United States
(12) Patent Application Publication
(10) Pub. No.: US 2021/0214260 A1
(43) Pub. Date: Jul. 15, 2021

(54) GLASS PRODUCT FORMING MOLD, GLASS PRODUCT FORMING DEVICE, AND GLASS PRODUCT PROCESSING METHOD

(71) Applicant: AAC Optics Solutions Pte. Ltd., Singapore City (SG)

(72) Inventors: Peter Krohne Nielsen, Hillerød (DK); Simon Bo Jensen, Hillerød (DK); Michal Sobol, København (PL); Tsz Lok Keith Tang, Hong Kong (CN); Thomas Aabo, Albertslund (DK); Jacob Kibsgaard Kjær, Søborg (DK); Niels Christian Roemer Holme, Farum (DK); Bingke Zhu, Shenzhen (CN)

(21) Appl. No.: 16/809,591

(22) Filed: Mar. 5, 2020

(30) Foreign Application Priority Data
Jan. 9, 2020 (CN) 202010023206.1

(51) Int. Cl. C03B 11/08

(52) U.S. Cl. CPC C03B 11/08; C03B 2215/50; C03B 2215/46

(57) ABSTRACT

A glass product forming mold includes a first mold and a second mold opposite to the first mold, a flat glass is formed into a three-dimensional glass structure after the first mold and the second mold are molded together. The first mold includes a first molding surface, a bottom surface, a side surface connecting the first molding surface and the bottom surface, and a first inclined surface; the second mold includes a second molding surface; and the first inclined surface extends to connect to the side surface from an edge of the first molding surface along a direction away from the first molding surface and the second mold. A thermal expansion coefficient of the first mold is smaller than that of the flat glass. Before complete cooling, the three-dimensional glass structure has been separated from the first molding surface, avoiding the deformation and rupture of the three-dimensional glass structure.

### TECHNICAL FIELD

The disclosure relates to the formation of glass products, and more particularly to a mold and device for forming a glass product, and method of processing the glass product.

### BACKGROUND

Lenses are optical elements made of transparent materials (such as glass, crystal, etc.), which can be widely used in security, vehicle, digital camera, laser, optical instruments, and other fields. With the continuous expansion of the market, the application of lens is more and more extensive. Especially with the development of the Internet, various electronic devices are brought into daily lives, such as mobile phones, tablet computers, laptops, etc. Specification requirements of lens applied in those electronic devices are also highly increased.

In the related art, the wafer lenses made of glass materials are generally produced by a glass processing mold through thermoforming. When the glass processing mold is enclosed, cavities with a preset shape will be encircled inside the glass processing mold, the cavities can help shape the heated glass substrate, and then the glass substrate is cooled to form glass products with a preset shape. The glass product will be directly attached to a forming surface to cool due to gravity and sticking.

However, the processing of the glass processing mold in the related art has the following problems:

Firstly, FIG. 6 illustrates that at the last step of the molding process, the glass product 301 may be stuck together with the feature points 303 (namely the site where the lens is formed) of the mold 302, or it may be stuck together with the mold at a random point 304 (namely any point of the forming surface) to form a point contact, where an arrow represents the shrinkage direction of the glass product. Contacting area of the glass product contacting with the mold tends to cool faster for the mold is cooled, and it may cause an uneven shrinkage across the glass product, leading to a deformation of the glass product 301, as shown in FIG. 7.

Secondly, in the forming process, the glass product 301 shows a strong adhesion to the mold 302 surface. Although adhesion will gradually reduce during the cooling process, it takes a long time for the glass product 301 to completely cool that leads to an auto release, thus increasing the cost. Besides, if the adhesion is too strong, the glass product 301 tends to crack.

Thirdly, the mold 302 with large angle feature will increase the risk of breakage of the glass product 301 during the process of shrinkage, because the shrinkage rate of the glass product 301 in the cooling process is greater than that of the mold 302, and the large angle feature of the mold 302 will prevent the glass product 301 from freely shrinking in the horizontal direction. The larger the diameter of the glass product 301, the greater the impact. Because the thermal expansion coefficient of the glass product 301 is larger than that of the mold 302, the shrinkage of the glass product 301 will be larger. As shown in FIG. 8, where an arrow indicates the shrinkage direction of the glass product and the mold. When the strain caused by the shrinkage difference between the mold and the glass product 301 goes beyond the strain that the glass product can sustain, the glass product 301 will crack, as shown in FIG. 9.

Therefore, it is necessary to provide an improved mold to solve the above problems.

### SUMMARY

One of the objectives of the disclosure is to provide a glass product forming mold, so as to solve the problem that the product quality is adversely affected by the existing glass processing molds.

One of the objectives of the disclosure is realized by adopting the following technical scheme:

Provided is a glass product forming mold comprising:

a first mold comprising:

a first molding surface;

a bottom surface being opposite to the first molding surface;

a side surface connecting the first molding surface and the bottom surface; and

a first inclined surface; and

a second mold being opposite to the first mold and comprising a second molding surface opposite to the first molding surface;

wherein the first inclined surface extends to connect to the side surface from an edge of the first molding surface along a direction away from the first molding surface and the second mold; a flat glass is formed into a three-dimensional glass structure after the first mold and the second mold are molded together; the first molding surface is opposite to the second mold, the bottom surface is away from the second mold; a thermal expansion coefficient of the first mold is smaller than that of the flat glass.

As an improvement, the first molding surface comprises a protrusion towards the second mold, the second molding surface defines a cavity away from the first mold, and the cavity is engaged with the protrusion.

As an improvement, the first mold comprises an extending portion and a base; the extending portion comprises the first molding surface and the first inclined surface; the base comprises the bottom surface and the side surface; and the extending portion is a frustum of a cone.

As an improvement, the second mold comprises a second inclined surface extending from an edge of the second molding surface, away from the protrusion, and towards the first mold; the second molding surface and the second inclined surface form a containing chamber for receiving the extending portion, and the containing chamber is engaged with the extending portion.

As an improvement, the side surface extends vertically from an edge of the bottom surface to an end of the first inclined surface away from the first molding surface.

The disclosure also provides a glass forming device comprising the aforesaid glass product forming mold and a driving mechanism; the driving mechanism is configured to drive one of the first mold and the second mold to move towards or away from the other.

As an improvement, the first molding surface comprises a protrusion towards the second mold, the second molding surface defines a cavity away from the first mold, and the cavity is engaged with the protrusion.

As an improvement, the first mold comprises an extending portion and a base; the extending portion comprises the first molding surface and the first inclined surface; the base comprises the bottom surface and the side surface; and the extending portion is a frustum of a cone.

As an improvement, the second mold comprises a second inclined surface extending from an edge of the second molding surface, away from the protrusion, and towards the first mold; the second molding surface and the second inclined surface form a containing chamber for receiving the extending portion, and the containing chamber is engaged with the extending portion.

As an improvement, the side surface extends vertically from an edge of the bottom surface to an end of the first inclined surface away from the first molding surface.

The disclosure also provides a method of processing a glass product, comprising:

providing the aforesaid glass forming device and a flat glass;

placing the flat glass on the first molding surface, driving, by the driving mechanism, one of the first mold and the second mold to move towards the other, to hot-press the flat glass into a three-dimensional glass structure;

driving, by the driving mechanism, one of the first mold and the second mold to move away from the other;

separating the three dimensional glass from the first molding surface when the three dimensional glass automatically moves towards the second mode along the first inclined surface because a cooling shrinkage of the three dimensional glass is larger than that of the first mold.

As an improvement, the first molding surface comprises a protrusion towards the second mold, the second molding surface defines a cavity away from the first mold, and the cavity is engaged with the protrusion.

As an improvement, the first mold comprises an extending portion and a base; the extending portion comprises the first molding surface and the first inclined surface, and the base comprises the bottom surface and the side surface; the extending portion is a frustum of a cone.

As an improvement, the second mold comprises a second inclined surface extending from an edge of the second molding surface, away from the protrusion, and towards the first mold; the second molding surface and the second inclined surface form a containing chamber for receiving the extending portion, and the containing chamber is engaged with the extending portion.

As an improvement, the side surface extends vertically from an edge of the bottom surface to an end of the first inclined surface away from the first molding surface.

Compared with the related art, the first mold comprises a first molding surface and a first inclined surface, and the first inclined surface extends from the edge of the first molding surface and away from the first molding surface and the second mold; closing the first mold and the second mold can mold a flat glass into a three-dimensional glass structure; after the first mold is separated from the second mold, the three-dimensional glass structure and the first mold start to cool down and shrink. Because the thermal expansion coefficient of the first mold is smaller than the thermal expansion coefficient of the three-dimensional glass structure, the shrinkage of the first mold will be smaller than the shrinkage of the three-dimensional glass structure, and the three-dimensional glass structure will automatically move towards the second mold along the first inclined surface. Before complete cooling, the three-dimensional glass structure has been separated from the first molding surface, eliminating the influence of the difference of the thermal expansion coefficient between the three-dimensional glass structure and the first mold, making the cooling of the three-dimensional glass structure more uniform. The first mold does not obstruct the shrinkage of the three-dimensional glass structure, thus avoiding the deformation and rupture of the three-dimensional glass structure.

### BRIEF DESCRIPTION OF THE DRAWINGS

FIG. 1 is a schematic diagram of one exemplary embodiment of a glass product forming mold and a three-dimensional glass structure;

FIG. 2 is a sectional view taken along line A-A of FIG. 1;

FIG. 3 is a schemtic diagram of a first mold of FIG. 1;

FIG. 4 is a schemtic diagram of a second mold of FIG. 1;

FIG. 5 is a schematic diagram of one exemplary embodiment of a three-dimensional glass structure;

FIG. 6 is a schematic diagram of a glass product and a mold in a related art;

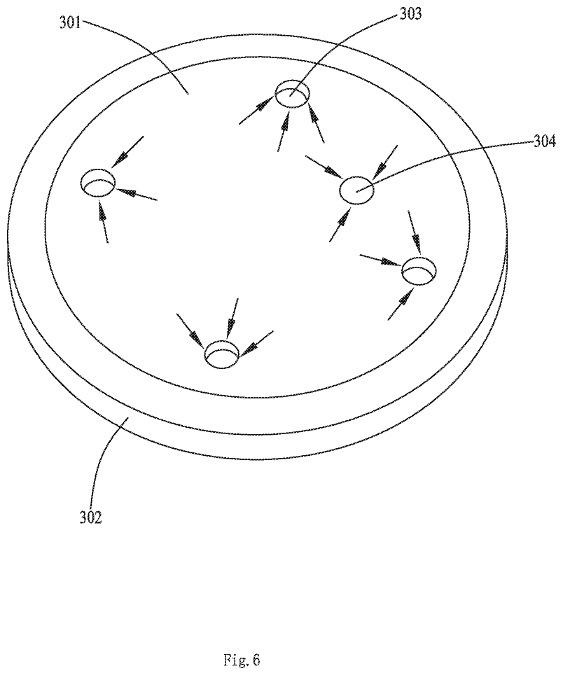

FIG. 7 is a diagrammatic view of the deformation of the glass product due to uneven heat distribution of FIG. 6;

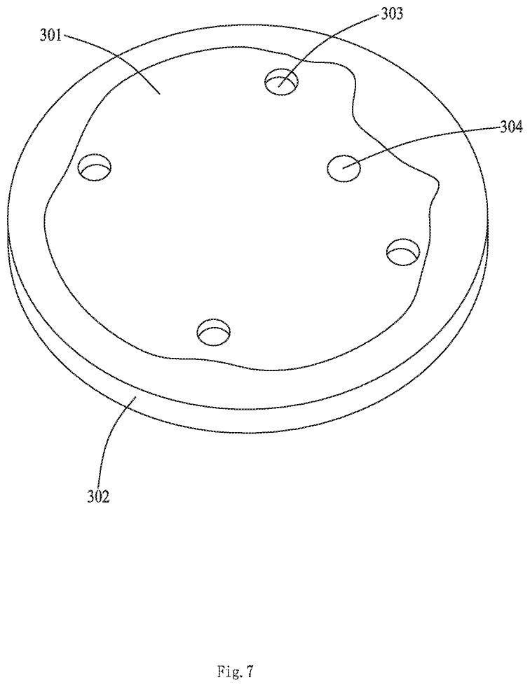

FIG. 8 is a diagrammatic view of the glass product and the mold being contracted of FIG. 6; and

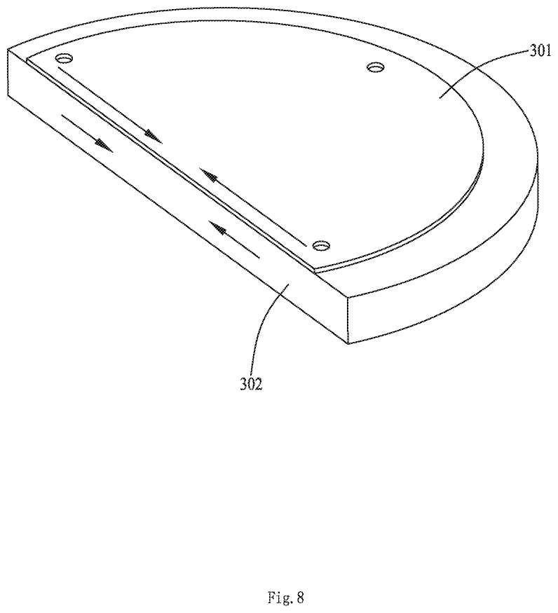

FIG. 9 is a diagrammatic view of the broken glass product due to contracted difference of FIG. 6.

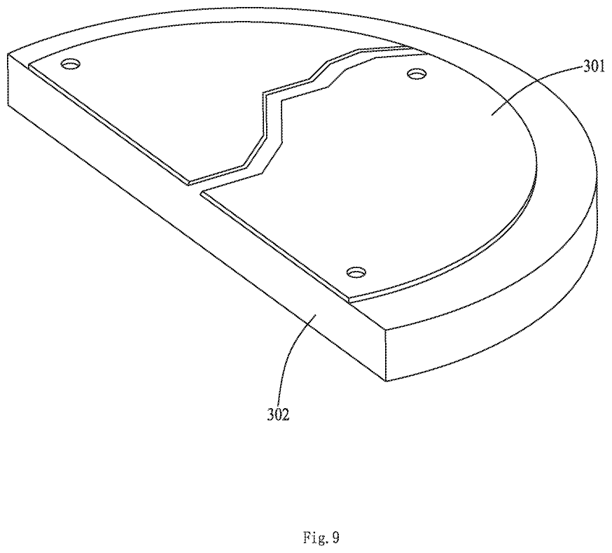

In the drawings, the following reference numbers are used: 100. Glass product forming mold; 10. First mold; 20. Second mold; 11. First molding surface; 12. Bottom surface; 13. Side surface; 14. First inclined surface; 111. Protrusion; 21. Second molding surface; 211. Cavity; 200. Three-dimensional glass; 201. Straight portion; 202. Bending portion; 203. Lens; 15. Extending portion; 16. Base; 22. Second inclined surface; 23. Containing chamber.

### DETAILED DESCRIPTION OF THE PREFERRED EMBODIMENTS

The disclosure is described in detail below in combination with the drawings.

It should be noted that all directional indications (such as up, down, left, right, front, rear, inside, outside, top, bottom, . . . ) in the embodiment of the disclosure are only used to explain the relative position relationship among the components under a certain attitude (as shown in the attached figure), etc. if the specific attitude changes, the directivity indication will change accordingly.

It should also be noted that when a component is called “fixed to” or “disposed on” another component, the component can directly interacts with another component or there may be an intermediate component at the same time. When a component is referred to as “connecting to” another component, it can be directly connected to another component or there may be an intermediate component at the same time.

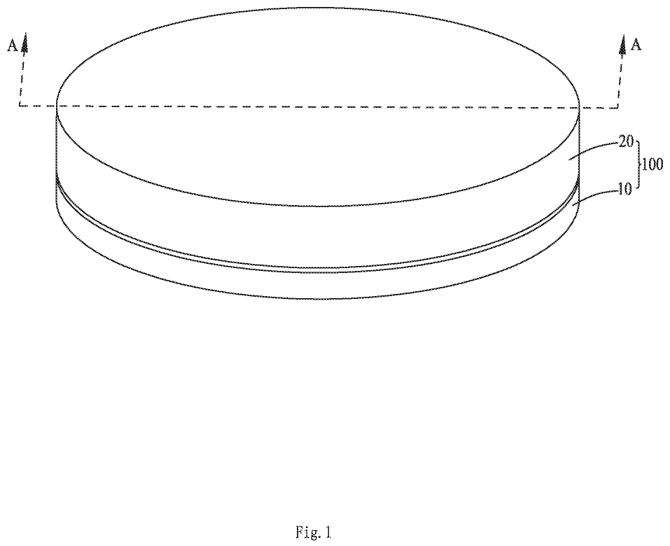

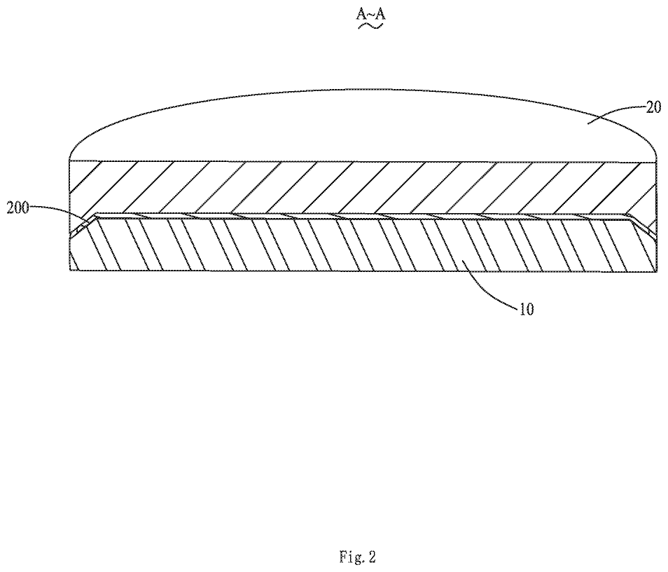

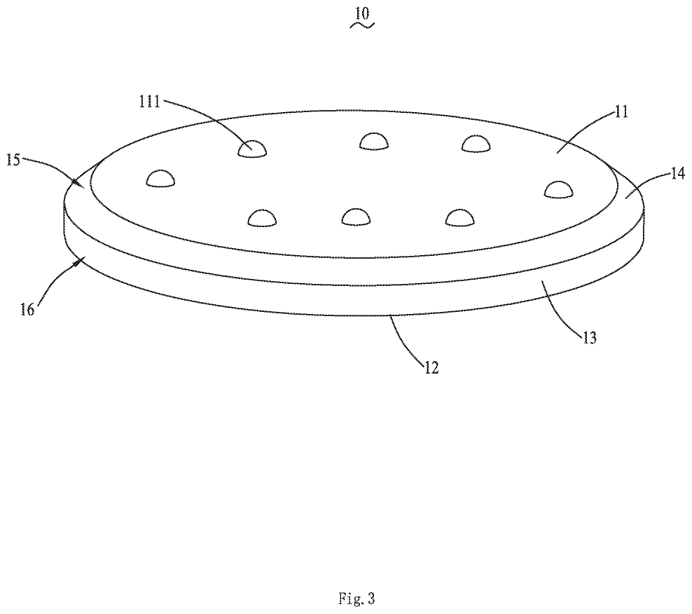

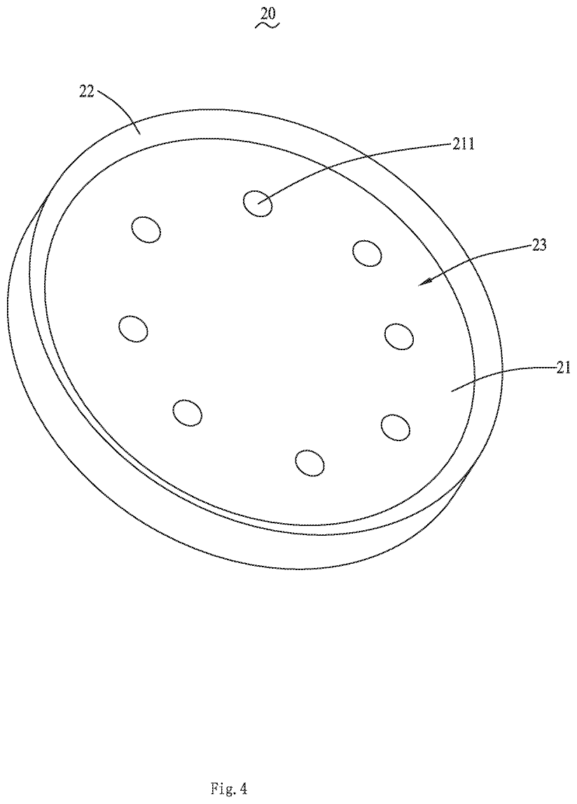

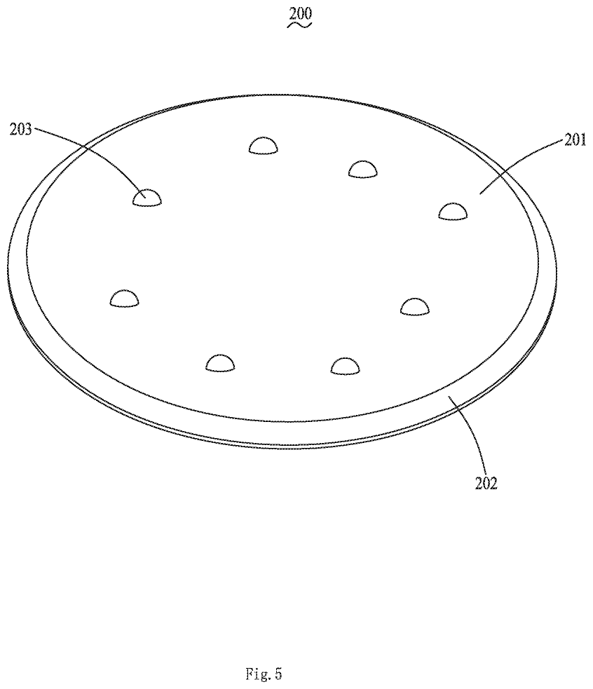

As shown in FIGS. 1-5, the disclosure provides a glass forming device comprising a glass product forming mold 100 and a driving mechanism. The glass product forming mold 100 comprises a first mold 10 and a second mold 20 opposite to the first mold 10. In one exemplary embodiment, the first mold 10 is preferably a fixed mold, and the second mold 20 is preferably a movable mold. The driving mechanism is used to drive the second mold 20 to move towards or away from the first mold 10 to finish die sinking or die assembly of the glass product forming mold 100. It can be understood that the first mould 10 can be a movable mold and the second mold 20 can be a fixed mold, so long as one of the two molds can move relative to the other one.

Preferably, the first mold 10 comprises a first molding surface 11, a bottom surface 12, a side surface 13, and a first inclined surface 14. The first molding surface 11 is opposite to the second mold 20. The first molding surface 11 comprises a protrusion 111 towards the second mold 20. The bottom surface 12 is opposite to the first molding surface 11 and away from the second mold 20. The side surface 13 extends from an edge of the bottom surface 12 towards the first molding surface 11. The first inclined surface 14 extends to connect to the side surface 13 from an edge of the first molding surface 14 along a direction away from the first molding surface 11 and the second mold 20, that is, the first inclined surface 14 tilts outwards and extends to connect to the side surface 13 from the edge of the first molding surface 14 and away from the second mold 20. The second mold 20 comprises a second molding surface 21 opposite to the first molding surface 11. The second molding surface 21 defines a cavity 211 away from the first mold 10 and being engaged with the protrusion 111. Preferably, a plurality of the protrusion 111 and the cavity 211 are provided, and they are the same in number. One protrusion 111 is engaged with one cavity 211.

When the first mold 10 and the second mold 20 will be molded together, the driving mechanism drives the second mold 20 to move toward the first mold 10, thereby pressing a flat glass placed on the first molding surface 11 into a three-dimensional glass structure 200. The thermal expansion coefficient of the flat glass is greater than the thermal expansion coefficient of the first mold 10.

In one exemplary embodiment, the three-dimensional glass structure 200 comprises a straight portion 201 which is attached to the first molding surface 11 and the second molding surface 21, and a bending portion 202 which surrounds an edge of the straight portion 201 and is attached to the first inclined surface 14. A glass product is formed between the protrusion 111 and the cavity 211, and the glass product is preferably a lens 203 in the example. It can be understood that the glass product is not limited to the lens 203, and it can also be a grating or other products. Among them, the thermal expansion coefficient refers to the expansion and contraction of objects due to the change of temperature. The greater the thermal expansion coefficient is, the more the contraction degree will be, and vice versa.

After the glass product is formed, the driving mechanism drives the second mold 20 to move away from the first mold 10, namely, performing die sinking, so that the three-dimensional glass structure 200 is separated from the second mold 20, and the three-dimensional glass structure 200 and the first mold 10 start to shrink.

Because the shrinkage of the three-dimensional glass structure 200 is faster than the shrinkage of the first mold 10, the bending portion 202 slides along the first inclined surface 14 and moves away from the bottom surface 12 to drive the straight portion 201 to move together, so that the straight portion 201 is separated from the first molding surface 11 and the glass product is separated from the protrusion 111 before the three-dimensional glass structure 200 is completely cooled. Thus, the shrinkage process of the straight portion 201 is not affected by the first mold 10, and the influence resulting from the difference of the thermal expansion coefficient between the three-dimensional glass structure 200 and the first mold 10 is eliminated, so that the cooling of the straight portion 201 is uniform, and the deformation and rupture of the three-dimensional glass structure 200 is avoided, thereby ensuring the quality of the glass product. The contact area of the three-dimension glass 200 with the first mold 10 is gradually reduced during the cooling process, so the cooling speed of the three-dimensional glass structure 200 is accelerated, thus shortening the production cycle, and reducing the cost.

It can be understood that the cavity 211 and the protrusion 111 are not limited to the above arrangement modes. For example, it is also possible to dispose the protrusion 111 on the second molding surface 21, define the cavity 211 on the first molding surface 11, or the protrusion 111 and the cavity 211 are both disposed on the first molding surface 11, the cavity 211 and the protrusion 111 are correspondingly disposed on the second molding surface 21.

Preferably, the first mold 10 comprises an extending portion 15 and a base 16. The extending portion 15 comprises the first molding surface 11 and the first inclined surface 14, and the base 16 comprises the bottom surface 12 and the side surface 13. The extending portion 15 is a frustum of a cone.

The extending portion 15 is a frustum of a cone, that is to say, an unfolded structure of the side surface 13 is a sector ring, which can reduce the friction between the three-dimensional glass structure 200 and the extending portion 15, and is conducive to the self-sliding of the three-dimensional glass structure 200.

It can be understood that the extending portion 15 is not limited to the above-mentioned frustum of a cone, for example, a prism or an elliptical structure can also be used.

Preferably, the second mold 20 comprises a second inclined surface 22 extending from an edge of the second molding surface 21, away from the protrusion 111, and towards the first mold 10, that is, the second inclined surface 22 extends outward from the edge of the second molding surface 21 towards the first mold 10, and the second inclined surface 22 is parallel to the first inclined surface 14. The second molding surface 21 and the second inclined surface 22 form a containing chamber 23 for receiving the extending portion 15, and the containing chamber 23 is engaged with the extending portion 15, both are a frustum of a cone, and the unfolded structure of the second inclined surface 22 is also a sector ring.

Preferably, the side surface 13 extends vertically from the edge of the bottom surface 12 to an end of the first inclined surface 14 away from the first molding surface 11.

In one exemplary embodiment, the base 16 is a cylindrical structure, and a diameter of a top part of the base 16 is the same as that of the bottom of the extending portion 15. It is understandable that the diameter of the top part of the base 16 is smaller than or larger than the diameter of the extending portion 15.

The disclosure also provides a method of processing a glass product, comprising:

placing the flat glass on the first molding surface 11, and driving, by the driving mechanism, the second mold 20 to move towards the first mold 10; after the second mold 20 contacts the flat glass, heating the flat glass and the glass product forming mold 100 to the glass transition temperature, the second mold 20 extrudes a part of the flat glass protruding the first molding surface 11; hot-pressing the flat glass into a three-dimensional glass structure 200 after the first mold 10 and the second mold 20 are molded together. The glass transition temperature refers to a temperature at which the glass can transform from a high elastic state to a glass state or from a glass state to a high elastic state. The glass product is in a high elastic state in the environment higher than the glass transition temperature; in the state, the glass product is easily deformed in the presence of an external force. The glass product is in a glass state in the environment lower than the glass transition temperature; in the state, the glass product has certain rigidity, it is difficult to deform even in the presence of an external force.

After the glass product is formed, the driving mechanism drives the second mold 20 to move away from the first mold 10, to finish die sinking.

Cool the three-dimensional glass structure 200 and the first mold 10, the three-dimensional glass structure 200 and the first mold 10 start to shrink, the bending portion 202 slides automatically along the first inclined surface 14 towards the second mold 20 to drive the straight portion 201 to move together, so that the straight portion 201 is separated from the first molding surface 11 prior to being completely cooled.

The above embodiments are only the preferred embodiments of the present disclosure, and do not limit the scope of the present disclosure. A person skilled in the art may make various other corresponding changes and deformations based on the described technical solutions and concepts. And all such changes and deformations shall also fall within the scope of the present disclosure.

1. A glass product forming mold, comprising:
a first mold comprising:
a first molding surface;
a bottom surface being opposite to the first molding surface;
a side surface connecting the first molding surface and the bottom surface; and
a first inclined surface; and
a second mold being opposite to the first mold and comprising a second molding surface opposite to the first molding surface;
wherein the first inclined surface extends to connect to the side surface from an edge of the first molding surface along a direction away from the first molding surface and the second mold; a flat glass is formed into a three-dimensional glass structure after the first mold and the second mold are molded together; the first molding surface is opposite to the second mold, the bottom surface is away from the second mold; a thermal expansion coefficient of the first mold is smaller than that of the flat glass.

2. The glass product forming mold of claim 1, wherein the first molding surface comprises a protrusion towards the second mold, the second molding surface defines a cavity away from the first mold, and the cavity is engaged with the protrusion.

3. The glass product forming mold of claim 1, wherein the first mold comprises an extending portion and a base; the extending portion comprises the first molding surface and the first inclined surface; the base comprises the bottom surface and the side surface; and the extending portion is a frustum of a cone.

4. The glass product forming mold of claim 3, wherein the second mold comprises a second inclined surface extending from an edge of the second molding surface, away from the protrusion, and towards the first mold; the second molding surface and the second inclined surface form a containing chamber for receiving the extending portion, and the containing chamber is engaged with the extending portion.

5. The glass product forming mold of claim 1, wherein the side surface extends vertically from an edge of the bottom surface to an end of the first inclined surface away from the first molding surface.

6. A glass forming device, comprising:
a glass product forming mold of claim 1; and
a driving mechanism;
wherein the driving mechanism is configured to drive one of the first mold and the second mold to move towards or away from the other.

7. The glass forming device of claim 6, wherein the first molding surface comprises a protrusion towards the second mold, the second molding surface defines a cavity away from the first mold, and the cavity is engaged with the protrusion.

8. The glass forming device of claim 6, wherein the first mold comprises an extending portion and a base; the extending portion comprises the first molding surface and the first inclined surface; the base comprises the bottom surface and the side surface; and the extending portion is a frustum of a cone.

9. The glass forming device of claim 8, wherein the second mold comprises a second inclined surface extending from an edge of the second molding surface, away from the protrusion, and towards the first mold; the second molding surface and the second inclined surface form a containing chamber for receiving the extending portion, and the containing chamber is engaged with the extending portion.

10. The glass forming device of claim 6, wherein the side surface extends vertically from an edge of the bottom surface to an end of the first inclined surface away from the first molding surface.

11. A method of processing a glass product, comprising:
providing a glass forming device of claim 6 and a flat glass;
placing the flat glass on the first molding surface, driving, by the driving mechanism, one of the first mold and the second mold to move towards the other, to hot-press the flat glass into a three-dimensional glass structure;
driving, by the driving mechanism, one of the first mold and the second mold to move away from the other;
separating the three dimensional glass from the first molding surface when the three dimensional glass automatically moves towards the second mode along the first inclined surface because a cooling shrinkage of the three dimensional glass is larger than that of the first mold.

12. The method of processing the glass product of claim 11, wherein the first molding surface comprises a protrusion towards the second mold, the second molding surface defines a cavity away from the first mold, and the cavity is engaged with the protrusion.

13. The method of processing the glass product of claim 11, wherein the first mold comprises an extending portion and a base; the extending portion comprises the first molding surface and the first inclined surface; the base comprises the bottom surface and the side surface; and the extending portion is a frustum of a cone.

14. The method of processing the glass product of claim 13, wherein the second mold comprises a second inclined surface extending from an edge of the second molding surface, away from the protrusion, and towards the first mold; the second molding surface and the second inclined surface form a containing chamber for receiving the extending portion, and the containing chamber is engaged with the extending portion.

15. The method of processing the glass product of claim 11, wherein the side surface extends vertically from an edge of the bottom surface to an end of the first inclined surface away from the first molding surface.
